(19) United States
(12) Patent Application Publication
(10) Pub. No.: US 2006/0203886 A1
(43) Pub. Date: Sep. 14, 2006

(54) Simplified thermal isolator for temperature sensor

(75) Inventor: Michael J. Karmazyn, Baltimore, MD (US)

Correspondence Address: VENABLE LLP, P.O. BOX 34385, WASHINGTON, DC, 20045-9998, US

(73) Assignee: AAI Corporation, Hunt Valley, MD (US)

(21) Appl. No.: 11/298,654

(22) Filed: Dec. 12, 2005

Related U.S. Application Data
(60) Provisional application No. 60/660,066, filed on Mar. 10, 2005.

(51) Int. Cl. G01K 1/00

(52) U.S. Cl. 374/208

(57) ABSTRACT

A thermal isolator is provided for use with a sensor having a sensing element. The isolator has a main body made of a thermally insulating material. The main body has an outer surface, a sensor receiving passage for receiving the sensor, and at least one venting port fluidly communicating with the sensor receiving passage and the outer surface. The sensor receiving passage is adapted to position the sensor such that the sensing element is unreachable by a linear path from the outer surface through any opening in the main body.

This application claims the benefit of U.S. Provisional Patent Application No. 60/660,066 filed Mar. 10, 2005, which is hereby incorporated by reference in its entirety.

### BACKGROUND OF THE INVENTION

The invention relates to the protection of sensors. More particularly, the invention relates to the protection of sensors from sun light or other energy sources. More particularly still, the invention relates to the protection of temperature sensors from sunlight or radiant energy sources.

### SUMMARY OF THE INVENTION

An embodiment of the invention provides a thermal isolator for use with a sensor having a sensing element. The isolator has a main body made of a thermally insulating material. The main body has an outer surface, a sensor receiving passage for receiving the sensor, and at least one venting port fluidly communicating with the sensor receiving passage and the outer surface. The sensor receiving passage is adapted to position the sensor such that the sensing element is unreachable by a linear path from the outer surface through any opening in the main body.

The invention also provides a thermal isolator for use with a sensor having a sensing element. The isolator has a main body made of a thermally insulating material. The main body has an outer surface, a sensor receiving passage for receiving the sensor, and at least one venting port fluidly communicating with the sensor receiving passage and the outer surface. The sensor receiving passage is adapted to position the sensor such that the sensing element is not directly viewable from the outer surface through any opening in the main body.

### BRIEF DESCRIPTION OF THE DRAWINGS

Further advantages and details of the invention follow from the exemplary embodiments and are explained in the following with the aid of the Figures, in which:

FIG. 1 is a side view of a first example of a thermal isolator in accordance with the invention;

FIG. 2 is a sectional view of the isolator shown in FIG. 1;

FIG. 3 is a sectional view of the isolator shown in FIG. 1 taken along section line II-II; and

FIG. 4 is a sectional view of a second example of a thermal isolator in accordance with the invention.

### DETAILED DESCRIPTION OF THE INVENTION

The invention will be described using the example of a thermal isolator for use with a temperature sensor. It is noted however that the invention can also be applied to other temperature sensor applications.

Temperature sensors are used in various situations to determine the temperature of a specific thing and/or a specific location. In many cases, the sensed temperature reading is used in a calculation for determining some other quantity. An example of such a calculation is a calculation for determining air density based on the temperature of the air.

Various external input can negatively affect the accuracy of a temperature sensor. For example, direct sunlight or radiant heat from, for example, a vehicle motor can increase the temperature reading of a temperature sensor and thus result in a reading that does not accurately reflect the ambient air temperature being measured. Sheets of material can be used to shield a temperature sensor from direct sunlight and other radiant energy sources. However, such shields can trap air heated by the energy source such that the sensor sees a temperature higher than the temperature of the ambient air. Shields can also be limited in the protection they provide when the sun or the source of radiant heat moves. The invention solves these problems in a very effective and inexpensive way.

An example of the invention will be described that uses cellular foam as the material for the thermal insulator. It is noted, however, that other thermally insulating materials can also be used. Cellular foam is a particularly good material to use for the thermal isolator because,.apart from its insulating properties, it can protect the temperature sensor from physical damage.

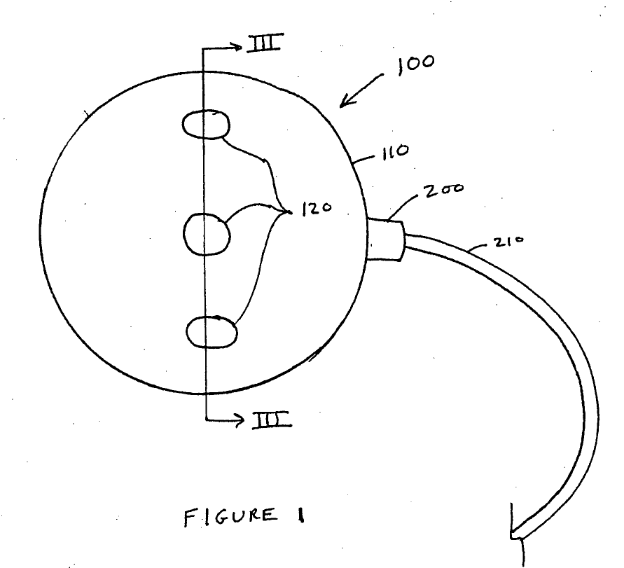

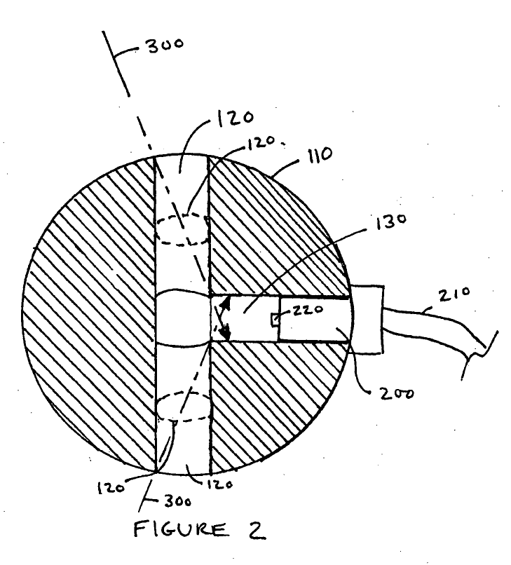

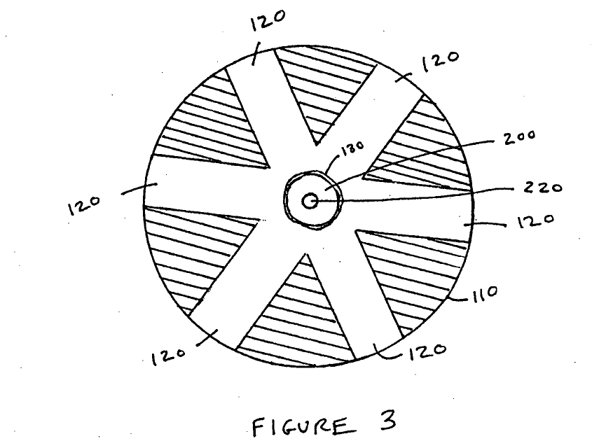

FIG. 1 shows an external view of a thermal isolator 100 that is an example of the invention. Thermal isolator 100 has a body 110 that is, in this example, spherical in shape. Body 110 of thermal isolator 100 is preferably made of a cellular foam material for at least the reasons discussed above. FIGS. 2 and 3 show sectional views of thermal isolator 100 that reveal a plurality, in this case six, venting ports 120 that are fluidly connected to a sensor receiving passage 130. Although six symmetrical venting ports are shown in this example, any number of venting ports and/or many non-symmetrical configurations can be used.

Sensor receiving passage 130 is adapted to receive a sensor 200 having a sensing element 220 such that sensing element 220 can measure conditions within sensor receiving passage 130. In this example, sensor 200 is a temperature sensor and sensing element 220 measures the temperature that exists in sensor receiving passage 130. The temperature of the air in sensor receiving passage 130 should, do to the features of the invention, be within an acceptable range of error when compared to the ambient air surrounding thermal isolator 100. Sensor 200 is connected, in this example, by a wire 210 to equipment that processes the output of sensor 200. It is noted that other types of connections, including wireless connections, could be used in lieu of, or in addition to, wire 210.

FIG. 2 shows light, or energy, paths 300. These paths represent rays of light or paths of other radiant energy in the vicinity of thermal insulator 100. Venting ports 120, sensor receiving passage 130, and the location of sensing element 220 in sensor receiving passage 130 are designed in the invention to ensure that no ray or beam (represented by exemplary paths 300) can directly touch sensing element 220. Venting ports 120 provide paths for natural convection in addition to preventing sunlight or radiant heat from directly impinging on sensing element 220. By this natural convection, a good portion of any heat that builds up inside thermal insulator 100 can be transferred to the ambient air outside of thermal insulator 100.

Body 110 of thermal isolator 100 can be colored to serve one or more purposes. While a white color serves to repel the absorption of heat, naturally white foam may not lend itself to long term exposure to sunlight without some form of undesirable degradation. As a result, a foamed material that is best suited to survive the effects of outdoor weathering may first be selected and then the exposed surfaces of the foam pigmented to add the necessary level of thermal reflection. In some instances, it may be desired to coat body 110 with an appropriate color that best suits a specific aesthetic requirement (such as camouflaging) while still maintaining an exceptional level of solar reflectivity.

Body 110 can be made, for example, of a closed cell foam or an open celled structure. While a closed cell foam may be a more desirable material from a heat insulation standpoint, the invention is not limited to the use of closed cell material.

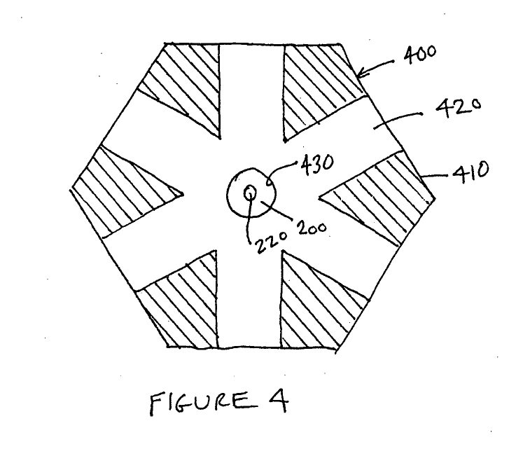

FIG. 4 shows an alternate embodiment of the invention. In the embodiment shown in FIG. 4, a thermal isolator 400 has a body 410 through which venting ports 420 are provided. In addition, a sensor receiving passage 430 is provided for housing sensor 200. FIG. 4 is analogous to FIG. 3, but shows a cross-section of a hexagonal shaped insulator as opposed to the spherical shaped insulator of FIG. 3. The embodiment shown in FIG. 4 has the advantage that it may simpler and/or less expensive to manufacture than the spherical embodiment. From the teachings of this disclosure, it would be apparent to one skilled in the art that shapes other than spherical and hexagonal can be used for a thermal insulator in accordance with the invention.

The invention is not limited to the above-described exemplary embodiments. It will be apparent, based on this disclosure, to one of ordinary skill in the art that many changes and modifications can be made to the invention without departing from the spirit and scope thereof.

What is claimed is:

1. A thermal isolator for use with a sensor having a sensing element, the isolator comprising:
a main body made of a thermally insulating material, the main body having an outer surface;
a sensor receiving passage for receiving the sensor; and
at least one venting port fluidly communicating with the sensor receiving passage and the outer surface,
wherein the sensor receiving passage is adapted to position the sensor such that the sensing element is unreachable by a linear path from the outer surface through any opening in the main body.

2. The thermal isolator of claim 1, wherein the venting port is a cylindrical passage passing completely through the main body.

3. The thermal isolator of claim 2, wherein an axis of the venting port is perpendicular to an axis of the sensor receiving passage.

4. The thermal isolator of claim 1, wherein the sensor is a temperature sensor.

5. The thermal isolator of claim 1, wherein the at least one venting port is a plurality of venting ports.

6. The thermal isolator of claim 5, wherein at least two of the venting ports are cylindrical passages passing completely through the main body.

7. The thermal isolator of claim 6, wherein the at least two venting ports each have an axis, the axes of the at least two venting ports being perpendicular to an axis of the sensor receiving passage.

8. The thermal isolator of claim 7, wherein the main body is spherical.

9. The thermal isolator of claim 7, wherein the main body is a hexagonal prism.

10. The thermal isolator of claim 9, wherein the main body is a right regular hexagonal prism.

11. A thermal isolator for use with a temperature sensor having a sensing element, the isolator comprising:
a main body made of a thermally insulating material, the main body having an outer surface;
a sensor receiving passage for receiving the sensor; and
at least one venting port fluidly communicating with the sensor receiving passage and the outer surface,
wherein the sensor receiving passage is adapted to position the sensor such that the sensing element is not directly viewable from the outer surface through any opening in the main body.

12. The thermal isolator of claim 11, wherein the venting port is a cylindrical passage passing completely through the main body.

13. The thermal isolator of claim 12, wherein an axis of the venting port is perpendicular to an axis of the sensor receiving passage.

14. The thermal isolator of claim 11, wherein the sensor is a temperature sensor.

15. The thermal isolator of claim 11, wherein the at least one venting port is a plurality of venting ports.

16. The thermal isolator of claim 15,.wherein at least two of the venting ports are cylindrical passages passing completely through the main body.

17. The thermal isolator of claim 16, wherein the at least two venting ports each have an axis, the axes of the at least two venting ports being perpendicular to an axis of the sensor receiving passage.

18. The thermal isolator of claim 17, wherein the main body is spherical.

19. The thermal isolator of claim 17, wherein the main body is a hexagonal prism.

20. The thermal isolator of claim 19, wherein the main body is a right regular hexagonal prism.
